(19) United States
(12) Patent Application Publication
(10) Pub. No.: US 2004/0181755 A1
(43) Pub. Date: Sep. 16, 2004

(54) Apparatus, method and computer program for keyword highlighting, and computer-readable medium storing the program thereof

(75) Inventors: Masaki Murata, Tokyo (JP); Kazuhiro Takeuchi, Tokyo (JP)

Correspondence Address: STAAS & HALSEY LLP, SUITE 700, 1201 NEW YORK AVENUE, N.W., WASHINGTON, DC, 20005, US

(73) Assignee: Communications Research Laboratory, Independent Administrative Institution, Tokyo (JP)

(21) Appl. No.: 10/795,243

(22) Filed: Mar. 9, 2004

(30) Foreign Application Priority Data
Mar. 12, 2003 (JP) 2003-067045

(51) Int. Cl. G06F 17/00

(52) U.S. Cl. 715/526

(57) ABSTRACT

To easily detect the position corresponding to the explanation of a detection area in input data, the apparatus sets an extraction unit, an extraction expression for a highlight, and the position of an extraction area. From the extraction area, an equivalent of the extraction unit is extracted, and an extracted unit corresponding to the extraction expression is stored in storage means. Then, input data is checked from the left. If an equivalent of the current extraction unit is stored in the storage means, it is highlighted.

### BACKGROUND OF THE INVENTION

1. Field of the Invention

This invention relates to an apparatus, method and computer program for defining a title or a word included in an area specified by a user as an important keyword and highlighting the keyword portion in body text.

2. Description of the Related Art

A title is generally considered to be the most important in a document. For example, assuming that a title portion is important, a high mark is assigned to the keyword appearing in the title portion to improve the precision of the information retrieval (q.v. Non-Patent Document 1). However, as described above, in the related art disclosed in Non Patent Document 1, the method with assigning a high mark to a keyword appearing in a title, it is hard to determine which portion of the text is important.

[Non-Patent Document 1: Maki Murata, Ma Sei, Kiyotaka Uchimoto, Hiromi Kotukuri, Masao Uchiyama, Hitoshi Isahara, “Information Retrieval using Position Information and Field Information”, Natural Language Processing (Association for Natural Language Processing), April, 2000, Vol 7, No. 2 P.141˜P. 160]

### SUMMARY OF THE INVENTION

The object of the present invention is provide a technique for highlighting a keyword portion in the body text of a document by defining a title or a word included in an area specified by a user as an important keyword to easily understand the important portion of the body text of document.

To solve the above-mentioned issue in the related art, the present invention comprises extraction unit setting means for setting an extraction unit; extraction expression setting means for setting an extraction expression for a highlight; extraction area setting means for setting the position of an extraction area; storage means for storing information; and extraction means. The extraction means extracts an equivalent of the extraction unit from the extraction area, stores an equivalent of the extraction expression in the storage means, and highlights an equivalent of the current extraction unit if it is stored in the storage means after checking the input data from the left. Consequently, the position corresponding to the explanation of the extraction area can be easily detected in the input text data.

### BRIEF DESCRIPTION OF THE DRAWINGS

FIG. 1 shows the principle configuration of the present invention;

FIG. 2 shows an example of configuration of the keyword highlighting apparatus according to an embodiment of the present invention;

FIG. 3 shows a flowchart of the process of the keyword highlighting apparatus according to an embodiment of the present invention;

FIG. 4 shows a flowchart of the process of specifically highlighting the words to be highlighted when two words to be highlighted are consecutive in an embodiment of the present invention;

FIG. 5 shows an example configuration of the keyword highlighting apparatus using the document difference detection device according to an embodiment of the present invention; and

FIG. 6 shows an example configuration of the document difference detection device according to an embodiment of the present invention.

### DETAILED DESCRIPTION OF THE PREFERRED EMBODIMENTS

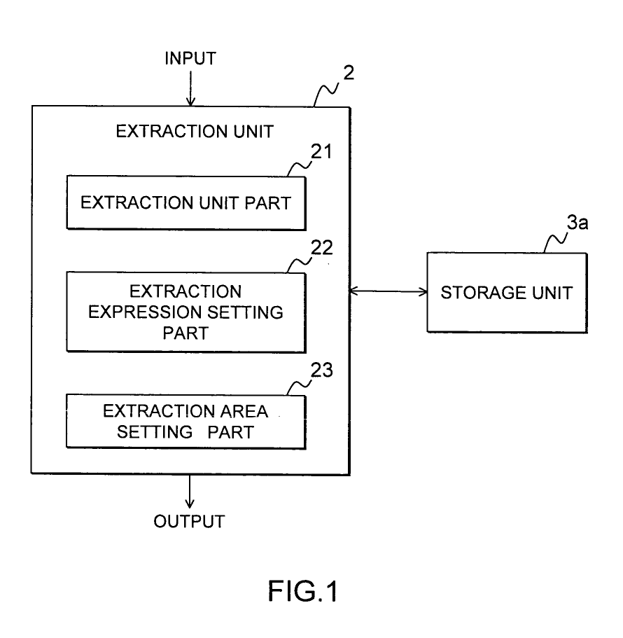

FIG. 1 shows the principle configuration of the present invention. FIG. 1 shows the configuration including extraction means 2, storage means 3a, extraction unit setting means 21, extraction expression setting means 22, and extraction area setting means 23.

The keyword highlighting apparatus according to the present invention comprises the following means.

(1) The keyword highlighting apparatus according to the present invention comprises: extraction unit setting means 21 for setting an extraction unit; extraction expression setting means 22 for setting an extraction expression for a highlight; extraction area setting means 23 for setting the position of an extraction area; storage means 3a for storing information; and extraction means 2. The extraction means 2 extracts an equivalent of the extraction unit from the extraction area, stores an equivalent of the extraction expression in the storage means 3a, and highlights an equivalent of the current extraction unit if it is stored in the storage means 3a after checking the input data from the left. Therefore, the position corresponding to the explanation of the extraction area can be easily detected in the input data.

(2) In the keyword highlighting apparatus described in (1) above, the extraction means 2 checks the input data from the left. If an equivalent of the current extraction unit is stored in the storage means 3a and if the extraction unit which is one unit before the current extraction unit is to be highlighted, then the extraction unit which is one unit before the current extraction unit and the current extraction unit are specifically highlighted. Therefore, the position explained as an extraction area can be more clearly detected in the input data.

(3) In the keyword highlighting apparatus described in (1) and (2) above, at least one of the settings of extraction expressions for highlight by the extraction expression setting means 22 is a noun. Therefore, only important portions such as a noun, etc. can be highlighted.

(4) In the keyword highlighting apparatus described in (1) to (3) above, the position of an extraction area is a title portion of the input data. Therefore, the position explained as a title portion to be an important data can be easily detected in the input data.

(5) In the keyword highlighting apparatus described in (1) to (3) above, the position of an extraction area is a portion specified by a user in the input data. Therefore, the position explained as the portion specified by a user can be easily detected in the input data.

(6) In the keyword highlighting apparatus described in (5) above, the extraction means 2 specifies a plurality of portions as the portions specified by a user, and differently highlighted depending on the specified portions. Therefore, the positions explained as a plurality of portions specified by the user can be easily detected in the input data.

(7) The keyword highlighting apparatus described in (5) and (6) above comprises a document difference detection device for highlighting an equivalent of the extraction unit first detected in the input data. The keyword highlighting apparatus specifies a portion highlighted by the document difference detection device as a portion specified by a user. Therefore, the position explained as a portion specified by a user can be more clearly detected in the input data.

(8) The keyword highlighting apparatus described in (5) and (6) above, comprises a document difference detection device for setting a detection area which is an area unit for comparison in detecting a difference between input data, extracting equivalents of all extraction units from an area other than the current detection area of the input data, and highlighting an equivalent of an extraction unit not detected in the area other than the detection area. The keyword highlighting apparatus specifies a portion highlighted by the document difference detection device as a portion specified by a user. Therefore, a position explained as a portion specified by the user can be more clearly detected in the input data.

(9) The keyword highlighting apparatus comprises: extraction unit setting means 21 for setting an extraction unit; extraction area setting means 22 for setting the position of an extraction area; storage means 3a for storing information; extraction means 2; and a document difference detection device for highlighting an equivalent of the extraction unit first detected in the input data. The extraction means 2 defines the portion highlighted by the document difference detection device as the position of the extraction area, extracts an equivalent of the extraction unit from the extraction area and stores it in the storage means 3a, checks the input data from the left, and highlights an equivalent of the current extraction unit if it is stored in the storage means 3a. Therefore, the position explained as the position corresponding to an extraction unit such as a word, etc. first detected in the input data can be easily and clearly detected.

(10) The keyword highlighting apparatus comprises extraction unit setting means 21 for setting an extraction unit; extraction area setting means 22 for setting the position of an extraction area; storage means 3a for storing information; extraction means 2; and a document difference detection device for setting a detection area which is an area unit for comparison in detecting the difference between the input data, extracting equivalents of all extraction units from the area other than the current detection area of the input data, and highlighting an equivalent of the extraction unit not in the area other than the detection area. The extraction means 2 defines the portion highlighted by the document difference detection device as the position of the extraction area, extracts an equivalent of the extraction unit from the extraction area and stores it in the storage means 3a, checks the input data from the left, and highlights an equivalent of the current extraction unit if it is stored in the storage means 3a. Therefore, the position explained as the position corresponding to an extraction unit such as a word, etc. first detected in the input data can be easily and clearly detected.

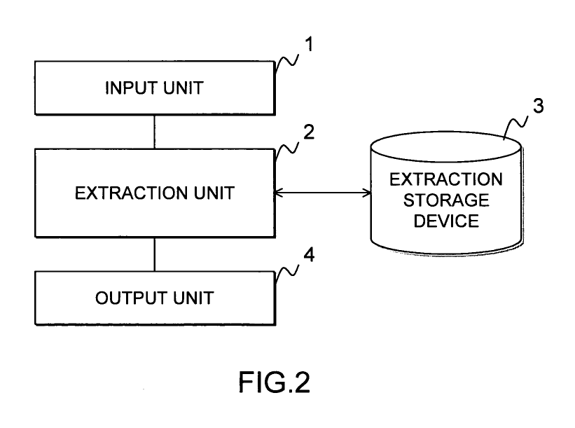

FIG. 2 shows an example of configuration of the keyword highlighting apparatus according to an embodiment of the present invention. In FIG. 2, the keyword highlighting apparatus comprises input means 1, extraction means 2, an extraction storage device 3, and output means 4. The input means 1 inputs the information using a keyboard, a mouse, a reader, etc. The extraction means 2 extracts a difference between input documents. The extraction storage device 3 is storage means for storing extraction such as a word, a kanji character, a noun phrase, etc. The output means 4 can be a display device, a printer, etc. and outputs information.

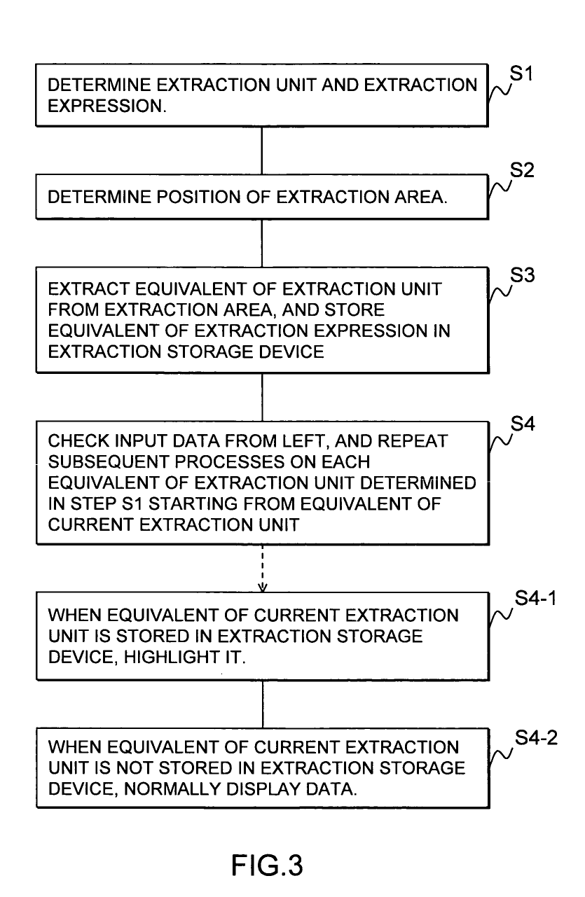

FIG. 3 shows a flowchart of the process of the keyword highlighting apparatus. The processes in S1 to S4-2 shown in FIG. 3 are described below.

S1: The input means 1 determines a unit of extraction (extraction unit) and an extraction expression. An extraction unit can be a “word”, “kanji character”, “noun phrase” or the like. An extraction expression can be an important part of speech, such as a “noun”, “verb” or the like. The extraction expression can be set by excluding unimportant parts of speech, such as a postpositional word, a verbal auxiliary, a space or the like.

S2: The position of an extraction area is determined in advance. An extraction area can be a title, an area specified by a user or the like. In the case of a title, a title portion is recognized (title recognition means) from the structure of the arrangement of a title. For example, in Web text, an SGML (standard generalized markup language) expression indicating a title is used. In other cases, when a title portion is written in a different font, or when line feed is given between a title portion and a text portion, it is assumed that the portion up to the line feed is a title portion. An area specified by a user by, for example, inverting an area using a mouse dragging operation, is recognized (specified area recognition means) as an inverted portion.

S3: The extraction means 2 extracts an equivalent of an extraction unit from an extraction area, and an equivalent of an extraction expression is stored in the extraction storage device 3. At this time, when an extraction unit is a Japanese word, it is necessary to perform a morpheme analysis to obtain a word. When it is an English word, a stemming algorithm is required. When a part of speech, etc. is used in specifying an extraction expression, a morpheme analysis or a system of applying a tag to a part of speech is required. A necessary system is used as the extraction means 2.

S4: The extraction means 2 checks input data from left, and repeats the following processes 4-1 and 4-2 on each of an equivalent of the extraction unit determined in the process S1 from an equivalent of the current extraction unit.

S4-1: When an equivalent of the current extraction unit is stored in the extraction storage device 3, the extraction means 2 highlights it.

S4-2: When an equivalent of the current extraction unit is not stored in the extraction storage device 3, the extraction means 2 does not highlight it, but normally displays it.

1) Explanation of Morpheme Analysis System

To divide Japanese text into words, a morpheme analysis system is required. ChaSen used by the extraction means 2 is described below. ChaSen is a morpheme analysis system developed in Nara High Technology University, and is disclosed by http://chasen.aist-nara ac.jp/index.html.jp.

The system divides Japanese text and predicts parts of speech of each word. For example, when “ [symbol] (gakkou he iku): go to school “is input, the following result is output.

[symbol] [symbol] school noun: general (gakkou)

[symbol] [symbol] to postpositional word: case postpositional word: (he) general

[symbol] [symbol] go verb: independent: 5 variations of row of ka, basic (iku) type EOS”

As described above, the text is divided into words each being arranged in each row, and each word is assigned a reading and the information about a part of speech. The divided word is used as an extraction unit, and an assigned part of speech is used in specifying an extraction expression.

2) Explanation of English Stemmer

When a word is extracted by the extraction means 2, only a stemming operation of returning a word into a basic form is required because the words in English text are written separately from one another. As an algorithm for stemming, for example, the famous Porter algorithm can be used <Porter, M. F., 1980, An algorithm for suffix stripping, Program, 14(3):130-137>.

As a system for assigning a part of speech to a word in English text (system of applying a tag of part of speech in English), a document of Brill is well known. The method disclosed in the document is used below. The output expression is similar to the method of the above-mentioned ChaSen [Eric Brill, Transformation-Based Error-Driven Learning and Natural Language Processing: A case Study in Part-of-Speech Tagging, Computational Linguistics, Vol.21, No.4, P.543-565, 1995].

Using a practical example, a highlighted keyword using a title is explained below in input and output examples. The article data as input examples is obtained from the corpus of the Mainichi Daily News.

### INPUT EXAMPLE 1

“<Extra> In this very year I will live a gentle life!

‘What I really cherish is/not the scale or the prosperity of the nation/the nation can be very small/has not a large number of what is called arms/but no one intends to use them’ Δ Oh, it is not what the future Japan is to be, but the words of Lao-tsu, a philosopher of the Ancient China. ‘Everybody living there/thinks highly of living and death/and therefore does not go out on boat or by car’ according to Lao-tsu Δ This is a paragraph of ‘Lao-tsu’ translated by Mr. Yoshizo Kato. Some years ago, he encountered Lao-tsu by acquiring an English translation of his work on a trip. Mr. Kato stayed in a cottage of Ina Valley in Nagano, and started translating more than ten volumes of English books into Japanese. The obsolete ‘Lao-tsu’ was amazingly renewed, and became modern Δ “When a troop bears up by all means, it is annihilated/A tree which firmly stands will be broken by the wind/What is flexible, soft, week, and delicate/will be enhanced and/is to bloom” is also described in his work. Japan has been a little too aggressive Δ The encounter of Mr. Kato with “Lao-tsu” is described in detail in ‘Lao-tsu’ in Ina Valley’ which serially run in the magazine ‘Gakutoh’. The Lao-tsu is not a fabled person in Chinese clothes, but seems to be an old gentleman in rainwear walking around the Ina Valley with an English book with him. Lao-tsu says, ‘What is significant is gentleness and softness’ Δ We seem to have kept in pursuit of strength and toughness rather than gentleness and softness. The prediction of Lao-tsu that ‘What seems to be feeble is followed by a tough and/a soft conquers a solid’ has a heavy effect on me. In this very year I will live a gentle life like the sunlight shining in the Ina Valley.”

### OUTPUT EXAMPLE 1

“<<<Extra> In this very year>> I will <<live a gentle life>>!

‘What I really cherish is/not the scale or the prosperity of the nation/the nation can be very small/has not a large number of what is called arms/but no one intends to use them’ Δ Oh, it is not what the future Japan is to be, but the words of Lao-tsu, a philosopher of the Ancient China. ‘Everybody living there/thinks highly of living and death/and therefore does not go out on boat or by car’ according to Lao-tsu Δ This is a paragraph of ‘Lao-tsu’ translated by Mr. Yoshizo Kato. Some years ago, he encountered Lao-tsu by acquiring an English translation of his work on a trip. Mr. Kato stayed in a cottage of Ina Valley in Nagano, and started translating more than ten volumes of English books into Japanese. The obsolete ‘Lao-tsu’ was amazingly renewed, and became modern Δ ‘When a troop bears up by all means, it is annihilated/A tree which firmly stands will be broken by the wind/What is flexible, soft, week, and delicate/will be enhanced and/is to bloom’ is also described in his work. Japan has been a little too aggressive Δ The encounter of Mr. Kato with ‘Lao-tsu’ is described in detail in ‘Lao-tsu’ in Ina Valley’ which serially run in the magazine ‘Gakutoh’. The Lao-tsu is not a fabled person in Chinese clothes, but seems to be an old gentleman in rainwear walking around the Ina Valley with an English book with him. Lao-tsu says, ‘What is significant is gentleness and softness’ Δ We seem to have kept in pursuit of strength and toughness rather than gentleness and softness. The prediction of Lao-tsu that ‘What seems to be feeble is followed by a tough and/a soft conquers a solid’ has a heavy effect on me. <<In this very year>> I will <<live a gentle life>> like the sunlight shining in the Ina Valley.”

In the input example 1, the title portion excluding a postpositional word, a verbal auxiliary, and a symbol of a space are defined as keywords. The morpheme analysis is performed by ChaSen. In the output example 1, what is enclosed by “<<”, “>>” (chevrons) is highlighted.

In the text in the output example 1, “<<In this very year>> I will <<live a gentle life>>” in the last line is highlighted, and it is apparent that the portion around here is important. Therefore, it is convenient for a reader to grasp the contents by reading the text around here.

### INPUT EXAMPLE 2

“President's Official Residence, etc. in Flames, Hard-fought Battles in the Heart of the Capital—Chechnia

[Kazutaka Iijima in Moscow on the 31^{st}] The Russian troops invaded the capital Grozny of Chechnia to the south of Russia, and attacked the heart of the capital by armored cars, etc. on the 31st. The President's official residence and some other buildings were set in flames. The Russian troops seem to have moved into the final stages of taking control of the capital.

According to the report from Grozny, after the fierce air strike and gunfire, the armored cars of the corps of the Russian troops proceeded to the vicinity of the President's official residence, and continue fierce street fighting with the corps of the Dudyev Administration in front of the President's official residence, etc.

On the other hand, the Commander of Defense of the Capital of the Dudyev Administration stated on television in the evening on the same day that the defense of the capital worked successfully, and reported that 50 combat cars of the Russian troops were destroyed. President Dudyev is now taking refuge in shelters safe in negotiations with the deputation of the Congress of Russia. President Dudyev offered a suggestion of a New Year cessation to President Yeltsin of Russia in the evening of the 30th, but Russia gave the silent treatment. (This article is provided with the “rough sketch of the downtown of Grozny)”

### OUTPUT EXAMPLE 2

“<<President's Official Residence>>, etc. <<in Flames>>, <<Hard-fought Battles>> in the <<Heart of the Capital>>—<<Chechnia>>

[Kazutaka Iijima in Moscow on the 31^{st}] The Russian troops invaded the <<capital>> Grozny of <<Chechnia>> to the south of Russia, and attacked the <<heart of the capital>> by armored cars, etc. on the 31st. The <<President's official residence>> and some other buildings were set <<in flames>>. The Russian troops seem to have moved into the final stages of taking control of the <<capital>>.

According to the report from Grozny, after the fierce air strike and gunfire, the armored cars of the corps of the Russian troops proceeded to the vicinity of the <<President's official residence>>, and continue fierce street fighting with the corps of the Dudyev Administration in front of the <<President's official residence>>, etc.

On the other hand, the Commander of Defense of the <<Capital>> of the Dudyev Administration stated on television in the evening on the same day that the defense of the <<capital>> worked successfully, and reported that 50 combat cars of the Russian troops were destroyed. <<President>> Dudyev is now taking refuge in shelters safe in negotiations with the deputation of the Congress of Russia. <<President>> Dudyev offered a suggestion of a New Year cessation to <<President>> Yeltsin of Russia in the evening of the 30th, but Russia gave the silent treatment. (This article is provided with the “rough sketch of the <<downtown>> of Grozny)”

In the text of the output example 2, it is apparent that the important keyword “Chechnia” is written in the first paragraph. If a reader is interested in “Chechnia”, it is clear that he or she is to specifically read the first paragraph.

### INPUT EXAMPLE 3

“<Islandlogy> In your Town/1 List of Donor Companies Found—Presentation Committee for Olympiad in Nagano

# Receives Orders of Constructions After Donations—Information to be on Public View #

Due to the lost bookkeeping information, details of a large amount of activity funds of the presentation committee for the Olympiad in Nagano have been unclear. The Mainichi Daily News acquired on the 31st the ‘list of the companies and the amounts’ indicating the breakdown of the donations to the official organizations most of which are managed by the staffers on loan of the Prefecture and the City. Of the donations of about one billion yen, the majority of them amounting to about 330 million yen were offered by the construction industry including the general contractors. Most of the companies received the orders of the Olympic game facilities and the civil engineering works after the donations. The presentation committee kept the names of the companies off the record for the reason of the privacy protection of the donors, but the list implies the ‘cozy relationship’ between the municipalities having the rights of placing the orders and the donor companies. On the other hand, the donations were spent as enormous amounts of money of 200 million yen on entertainment of the International Olympic Committee (IOC) and advertising videos. The gigantic event of the municipalities which control and manage taxes and tax-free donations is requested to be on public view (related articles on the city news page).

In the conference room on the eighth floor of the City Hall of Nagano where the Office of the presentation committee is located, some concerned members including the staffs of Nagano Prefecture and City, the local business leaders, etc. were summoned in April, 1990. ‘The funds are raised for the purposes . . . . ’

The leaders of the prefecture distributed the copies of the explanation to the participants. The sheet indicating the name of the presentation committee as the notes written in the margin read ‘Preparatory Plan for Funds’ including the items of ‘spending’, ‘income’, ‘deficits in budgets’, etc. with the respective amounts. The outstanding item was “Assignment of funds for deficits” for “Yokakai 200”. The unit was a million yen, that is, a total of 200 million yen was assigned to Yokakai.

Yokakai was a friendly party formed by 38 companies including large general contractors, etc. from other prefectures. One of those concerned with the construction industry said, ‘Practically, it was an organization of cozy relationship for controlling the orders of the constructions placed by the Prefecture’. The party was dismissed in the year before last in which the scandal of the general contractors occurred. An executive of a general contractor which offered the donations testified, ‘In July, 1990 (three months after the conference), one of the leaders of the prefecture requested Yokakai to offer the donations. Most of the companies offered the donations simultaneously in March in 1991’.

The presentation committee of the Winter Olympics in Nagano was founded as a voluntary association in October, 1989. The governor of Nagano, Mr. Yoshimura, was inaugurated as Chairman. The Olympiad in Tokyo and the Winter Olympics in Sapporo were the national projects, but the Olympiad in Nagano took the presentation activities led by the Prefecture and the City with the significance of independent municipality. According to the roll, 90% of the 51 members of the office were staffs of the Nagano prefecture, the city, and the related towns and villages. Mr. Yoshimura, the governor of the Prefecture, denied the request to Yokakai to offer the donations.

According to the donor list acquired by the Mainichi Daily News, the donors are listed by business type as per attached table. Among the construction and civil engineering companies, each of the twelve general contractors offered 10 million yen, and others offered 20 million, 5 million, 1.5 million respectively. A total of 600 or more construction, civil engineering, and construction material handling companies made contributions. The donations from the business and industries were offered through the Japan Amateur Athletic Association which is a specific public service corporation on the tax-free basis.

On the other hand, considering the relationship between the reception of orders and the donors concerned with the constructions of the facilities of the Olympic Games, the general contractors which received the orders and made the respective contracts for the facilities of figure skating, speed skating, ice hockey, bobsledding, luge, jumping, the main constructions of the opening and ending ceremony facilities, etc. offered donations of several million to ten million yen. A large communications equipment manufacturer offered as much as ten million yen which doubled the amount of the donations of other companies belonging to the same industry who offered about three to five million yen. In 1989 to 1992, this manufacturer received the order of the construction for nonflammable-type wireless digitized system of about a total of 3 billion yen which was a conspicuously large amount over the others'. The committee stated its activity funds of about 2.17 billion yen as income (601 million yen from the Prefecture, 230 million yen as a share from related cities, towns, and villages, 1.08 billion yen as donations from various companies, etc.) and about 1.96 billion yen as expenditures (the breakdown of 5 items including the advertising cost, etc.), and set the rest off the record.

# Huge Volume of Reports and Simple Explanation of Costs #

In June, 1991, the IOC General Conference in Birmingham decided the Olympiad in Nagano to be held as the 18th Winter Olympiad (in February, 1998) by rejecting four other cities including Salt Lake City of the USA. The presentation committee contributed the surplus of about 200 million yen to the Olympic Games Organization Committee in Nagano, and was dismissed in October, 1991 with a huge volume of presentation reports of 268 pages. However, the important cost for the presentation is explained on five pages only including a simple settling report followed by the ‘fund-raising records’ with the figures of about 1 billion yen and the number related companies, which is too little information about the report from the Prefecture to the citizens.

The year of 1995 has started after a half-century from the end of the World War II. The decentralization promotive law is taken up to the session of the Diet, and the nationwide local elections are called this year. The communalism is to be fundamentally reconsidered, and a new guide to what it ought to be should be proposed. In Part I of the ‘Islandlogy’ for consideration of communalism, the situation of ‘Your Town’ and the problems of the waste of tax, the closed information, etc. are checked from the viewpoint of a habitants and a taxpayer.

# Amounts of Donations by
Business Type (compiled by Mainichi Daily News) #

| Construction (general contractor, construction, bridges, | approx. |
|---|---|
| etc.) | 330 million yen |
| Development, real estate, housing | 74 |
| Banks, securities firms | 53 |
| Food-products companies | 42 |
| Computer, communications | 34 |
| Large electric facilities | 32 |
| Automobile industry | 26 |
| Electric appliance | 13 |
| Companies owned by habitants of Nagano Prefecture | 76″ |

### OUTPUT EXAMPLE 3

“<<<Islandlogy> In your>> <<Town>> <</1>> <<List of <<Donor Companies>> Found—Presentation Committee for Olympiad in Nagano>>

# Receives Orders of Constructions After <<Donations>> <<->> Information to be on Public View #

Due to the lost bookkeeping information, details of a large amount of activity funds of the <<presentation committee>> for the Olympiad in <<Nagano>> have been unclear. The Mainichi Daily News acquired on the 31st the ‘<<list>> of the <<companies>> and the amounts’ indicating the breakdown of the <<donations>> to the official organizations most of which are managed by the staffers on loan of the Prefecture and the City. Of the <<donations>> of about one billion yen, the majority of them amounting to about 330 million yen were offered by the construction industry including the general contractors. Most of the <<companies>> received the orders of the <<Olympic game>> facilities and the civil engineering works after the donations. The <<presentation committee>> kept the names of the <<companies>> off the record for the reason of the privacy protection of the <<donors>>, but the <<list>> implies the ‘cozy relationship’ between the municipalities having the rights of placing the orders and the donor <<companies>>. On the other hand, the donations were spent as enormous amounts of money of 200 million yen on entertainment of the International Olympic Committee (IOC) and advertising videos. The gigantic event of the municipalities which control and manage taxes and tax-free <<donations>> is requested to be on public view (related articles on the city news page).

In the conference room on the eighth floor of the City Hall of <<Nagano>> where the Office of the <<presentation>> committee is located, some concerned members including the staffs of <<Nagano>> Prefecture and City, the local business leaders, etc. were summoned in April, 1990. ‘The <<funds>> are raised for the purposes . . . ’

The leaders of the prefecture distributed the copies of the explanation to the participants. The sheet indicating the name of the <<presentation committee>> as the notes written in the margin read ‘Preparatory Plan for Funds’ including the items of ‘spending’, ‘income’, ‘deficits in budgets’, etc. with the respective amounts. The outstanding item was ‘Assignment of funds for deficits’ for ‘Yokakai 200’. The unit was a million yen, that is, a total of 200 million yen was assigned to Yokakai.

Yokakai was a friendly party formed by 38 companies including large general contractors, etc. from other prefectures. One of those concerned with the construction industry said, ‘Practically, it was an organization of cozy relationship for controlling the orders of the constructions placed by the Prefecture’. The party was dismissed in the year before last in which the scandal of the general contractors occurred. An executive of a general contractor which offered the donations testified, ‘In July, 1990 (three months after the conference), one of the leaders of the prefecture requested Yokakai to offer the donations. Most of the companies offered the donations simultaneously in March in 1991’.

The <<presentation>> committee of the Winter Olympics in<<Nagano>> was founded as a voluntary association in October, 1989. The governor of <<Nagano>>, Mr. Yoshimura, was inaugurated as Chairman. The <<Olympiad>> in Tokyo and the Winter Olympics in Sapporo were the national projects, but the Olympiad in<<Nagano>> took the <<presentation>> activities led by the Prefecture and the City with the significance of independent municipality. According to the roll, 90% of the 51 members of the office were staffs of the <<Nagano>> prefecture, the city, and the related towns and villages. Mr. Yoshimura, the governor of the Prefecture, denied the request to Yokakai to offer the <<donations>>.

According to the <<donor list>> acquired by the Mainichi Daily News, the donors are listed by business type as per attached table. Among the construction and civil engineering companies, each of the twelve general contractors offered 10 million yen, and others offered 20 million, 5 million, 1.5 million respectively. A total of 600 or more construction, civil engineering, and construction material handling companies made <<contributions>>. The <<donations>> from the business and industries were offered through the Japan Amateur Athletic Association which is a specific public service corporation on the tax-free basis.

On the other hand, considering the relationship between the reception of orders and the <<donors>> concerned with the constructions of the facilities of the <<Olympic Games>>, the general contractors which received the orders and made the respective contracts for the facilities of figure skating, speed skating, ice hockey, bobsledding, luge, jumping, the main constructions of the opening and ending ceremony facilities, etc. offered <<donations>> of several million to ten million yen. A large communications equipment manufacturer <<offered>> as much as ten million yen which doubled the amount of the donations of other companies belonging to the same industry who <<offered>> about three to five million yen. In 1989 to 1992, this manufacturer received the order of the construction for nonflammable-type wireless digitized system of about a total of 3 billion yen which was a conspicuously large amount over the others'.

The committee stated its activity funds of about 2.17 billion yen as income (601 million <<yen>> from the Prefecture, 230 million yen as a <<share>> from related cities, towns, and villages, 1.08 billion yen as<<donations>> from various companies, etc.) and about 1.96 billion yen as expenditures (the breakdown of 5 items including the advertising cost, etc.), and set the rest off the record.

# Huge Volume of Reports and Simple Explanation of Costs #

In June, 1991, the IOC General Conference in Birmingham decided the <<Olympiad in Nagano>> to be held as the 18th Winter Olympiad (in February, 1998) by rejecting four other cities including Salt Lake City of the USA. The <<presentation committee>> <<contributed>> the <<surplus>> of about 200 million yen to the <<Olympic Games>> Organization Committee in<<Nagano>>, and was dismissed in October, 1991 with a huge volume of <<presentation>> reports of 268 pages. However, the important cost for the <<presentation>> is explained on five pages only including a simple settling report followed by the ‘fund-raising records’ with the figures of about 1 billion yen and the number related <<companies>>, which is too little information about the report from the Prefecture to the citizens.

The year of 1995 has started after a half-century from the end of the World War II. The decentralization promotive law is taken up to the session of the Diet, and the nationwide local elections are called this year. The communalism is to be fundamentally reconsidered, and a new guide to what it ought to be should be proposed. In Part I of the ‘<<Islandlogy>>’ for consideration of communalism, the situation of ‘<<Your>> <<Town>>’ and the problems of the waste of tax, the closed information, etc. are checked from the viewpoint of a habitants and a taxpayer.

# Amounts of <<Donations>> by
Business Type (compiled by Mainichi Daily News) #

| | |
|---|---|
| Construction (general contractor, construction, bridges, | approx. |
| etc.) | 330 million yen |
| Development, real estate, housing | 74 |
| Banks, securities firms | 53 |
| Food-products companies | 42 |
| Computer, communications | 34 |
| Large electric facilities | 32 |
| Automobile industry | 26 |
| Electric appliance | 13 |
| Companies owned by habitants of <<Nagano>> | 76″ |
| Prefecture | |

In the text of the output example 3, it is apparent that the first paragraph containing a number of keywords is important. In the paragraph starting with “According to the <<donor list>> acquired by the Mainichi Daily News”, the information about the “donor list” is mainly described and useful for a reader. In this example, the first line is automatically recognized as a title.

Described below is an example of the case in which two words to be highlighted are consecutive. When two words to be highlighted are consecutive, the portion is specifically highlighted (specific highlight).

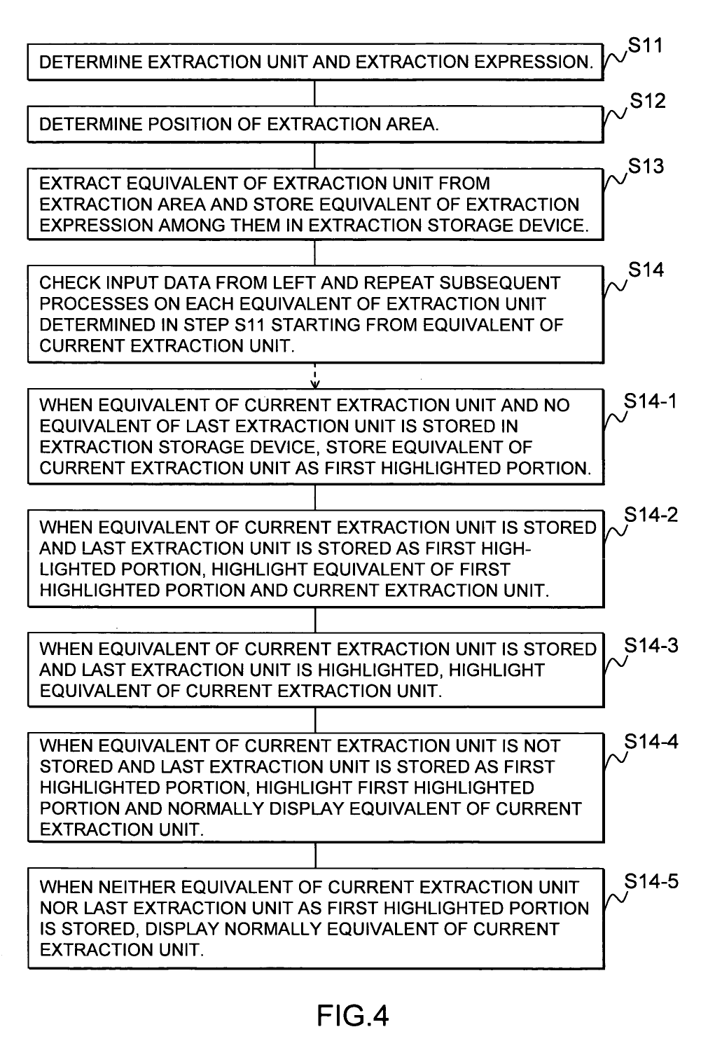

FIG. 4 shows a flowchart of the process of specifically highlighting the words to be highlighted when two words to be highlighted are consecutive. Described below are the processes of highlighting a keyword in the processes S11 to S14-5.

S11: The input means 1, etc. determines a unit of extraction (extraction unit) and an extraction expression. An extraction unit can be a “word”, “kanji character”, “noun phrase” or the like. An extraction expression can be a part of speech, such as a “noun” or the like. The extraction expression can be set by excluding unimportant parts of speech, such as a postpositional word, a verbal auxiliary, a space, a symbol or the like.

S12: The position of an extraction area is determined in advance. An extraction area can be a title, an area specified by a user. In the case of a title, a title portion is recognized from the structure of the arrangement of a title. For example, in Web text, an SGML (standard generalized markup language) expression indicating a title is used. In other cases, when a title portion is written in a different font, or when line feed is given between a title portion and a text portion, it is assumed that the portion up to the line feed is a title portion. An area specified by a user by, for example inverting an area using a mouse dragging operation is recognized as an inverted portion.

S13: The extraction means 2 extracts an equivalent of an extraction unit from an extraction area, and an equivalent of an extraction expression is stored in the extraction storage device 3. At this time, when an extraction unit is a Japanese word, it is necessary to perform a morpheme analysis to obtain a word. When it is an English word, a stemming algorithm is required. When a part of speech, etc. is used in specifying an extraction expression, a morpheme analysis or a system of applying a tag to a part of speech is required.

S14: The extraction means 2 checks input data from left, and repeats the following processes 14-1 and 14-5 on each of an equivalent of the extraction unit determined in the process S11 from an equivalent of the current extraction unit.

S14-1: When an equivalent of the current extraction unit is stored in the extraction storage device 3, and when an equivalent of an extraction unit which is one unit before the current extraction unit is not stored in the extraction storage device 3, the extraction means 2 stores an equivalent of the current extraction unit as the first highlighted portion.

S14-2: When an equivalent of the current extraction unit is stored in the extraction storage device 3, and when an extraction unit which is one unit before the current extraction unit is stored as the first highlighted portion, the extraction means 2 specifically highlights the first highlighted portion and an equivalent of the current extraction unit.

S14-3: When an equivalent of the current extraction unit is stored in the extraction storage device 3, and when an extraction unit which is one unit before the current extraction unit is specifically highlighted, the extraction means 2 specifically highlights an equivalent of the current extraction unit.

S14-4: When an equivalent of the current extraction unit is not stored in the extraction storage device 3, and when an extraction unit which is one unit before the current extraction unit is stored as the first highlighted portion, the extraction means 2 specifically highlights the first highlighted portion, and does not highlight an equivalent of the current extraction unit, but normally displays it.

S14-5: When an equivalent of the current extraction unit is not stored in the extraction storage device 3, and when an extraction unit which is one unit before the current extraction unit is not stored as the first highlighted portion, the extraction means 2 does not highlight an equivalent of the current extraction unit, but normally displays it.

In the following example, an extraction unit can be a word, and an extraction expression can be any word excluding a postpositional word, a verbal auxiliary, and a space character. That is, the extraction expression is a word of an important part of speech such as a noun, a verb or the like.

### INPUT EXAMPLE 1

“President's Official Residence, etc. in Flames, Hard-fought Battles in the Heart of the Capital—Chechnia

[Kazutaka Iijima in Moscow on the 31^{st}] The Russian troops invaded the capital Grozny of Chechnia to the south of Russia, and attacked the heart of the capital by armored cars, etc. on the 31st. The President's official residence and some other buildings were set in flames. The Russian troops seem to have moved into the final stages of taking control of the capital.

According to the report from Grozny, after the fierce air strike and gunfire, the armored cars of the corps of the Russian troops proceeded to the vicinity of the President's official residence, and continue fierce street fighting with the corps of the Dudyev Administration in front of the President's official residence, etc.

On the other hand, the Commander of Defense of the Capital of the Dudyev Administration stated on television in the evening on the same day that the defense of the capital worked successfully, and reported that 50 combat cars of the Russian troops were destroyed. President Dudyev is now taking refuge in shelters safe in negotiations with the deputation of the Congress of Russia. President Dudyev offered a suggestion of a New Year cessation to President Yeltsin of Russia in the evening of the 30th, but Russia gave the silent treatment. (This article is provided with the “rough sketch of the downtown of Grozny)”

### OUTPUT EXAMPLE 1

“<<<<President's Official Residence>>>>, etc. <<in Flames>>, <<<<Hard-fought Battles>>>> in the <<<<Heart of the Capital>>>>—<<<<Chechnia>>>>

[Kazutaka Iijima in Moscow on the 31st] The Russian troops invaded the <<capital>> Grozny of <<<<Chechnia>>>> to the south of Russia, and attacked the <<<<heart of the capital>>>> by armored cars, etc. on the 31st. The <<<<President's official residence>>>> and some other buildings were set <<in flames>>. The Russian troops seem to have moved into the final stages of taking control of the <<capital>>.

According to the report from Grozny, after the fierce air strike and gunfire, the armored cars of the corps of the Russian troops proceeded to the vicinity of the <<<<President's official residence>>>>, and continue fierce street fighting with the corps of the Dudyev Administration in front of the <<President's official residence>>, etc.

On the other hand, the Commander of Defense of the <<Capital>> of the Dudyev Administration stated on television in the evening on the same day that the defense of the <<capital>> worked successfully, and reported that 50 combat cars of the Russian troops were destroyed. <<President>> Dudyev is now taking refuge in shelters safe in negotiations with the deputation of the Congress of Russia. <<President>> Dudyev offered a suggestion of a New Year cessation to <<President>> Yeltsin of Russia in the evening of the 30th, but Russia gave the silent treatment. (This article is provided with the “rough sketch of the <<downtown>> of Grozny)”

In this case, a “normally highlighted portion” is enclosed by “<<” and “>>” (double chevrons), and a “specifically highlighted portion” is enclosed by “<<<<” and “>>>>” (two double chevrons). There are a number of “normally highlighted” portions, but there are not so many “specifically highlighted portions” and therefore outstanding. There are no “specifically highlighted portions” in the third paragraph, and it is apparent that this paragraph is not so important. Although double chevrons are used for highlight in this example, any highlight can be used. For example, a normal character can be printed in black, a normally highlighted portion can be printed in blue, and a specifically highlighted portion can be printed in red.

### INPUT EXAMPLE 2

“<Islandlogy> In your Town/1 List of Donor Companies Found—Presentation Committee for Olympiad in Nagano

# Receives Orders of Constructions After Donations—Information to be on Public View #

Due to the lost bookkeeping information, details of a large amount of activity funds of the presentation committee for the Olympiad in Nagano have been unclear. The Mainichi Daily News acquired on the 31st the ‘list of the companies and the amounts’ indicating the breakdown of the donations to the official organizations most of which are managed by the staffers on loan of the Prefecture and the City. Of the donations of about one billion yen, the majority of them amounting to about 330 million yen were offered by the construction industry including the general contractors. Most of the companies received the orders of the Olympic game facilities and the civil engineering works after the donations. The presentation committee kept the names of the companies off the record for the reason of the privacy protection of the donors, but the list implies the ‘cozy relationship’ between the municipalities having the rights of placing the orders and the donor companies. On the other hand, the donations were spent as enormous amounts of money of 200 million yen on entertainment of the International Olympic Committee (IOC) and advertising videos. The gigantic event of the municipalities which control and manage taxes and tax-free donations is requested to be on public view (related articles on the city news page).

In the conference room on the eighth floor of the City Hall of Nagano where the Office of the presentation committee is located, some concerned members including the staffs of Nagano Prefecture and City, the local business leaders, etc. were summoned in April, 1990.

‘The funds are raised for the purposes . . . . ’

The leaders of the prefecture distributed the copies of the explanation to the participants. The sheet indicating the name of the presentation committee as the notes written in the margin read ‘Preparatory Plan for Funds’ including the items of ‘spending’, ‘income’, ‘deficits in budgets’, etc. with the respective amounts. The outstanding item was ‘Assignment of funds for deficits’ for ‘Yokakai 200’. The unit was a million yen, that is, a total of 200 million yen was assigned to Yokakai.

Yokakai was a friendly party formed by 38 companies including large general contractors, etc. from other prefectures. One of those concerned with the construction industry said, ‘Practically, it was an organization of cozy relationship for controlling the orders of the constructions placed by the Prefecture’. The party was dismissed in the year before last in which the scandal of the general contractors occurred. An executive of a general contractor which offered the donations testified, ‘In July, 1990 (three months after the conference), one of the leaders of the prefecture requested Yokakai to offer the donations. Most of the companies offered the donations simultaneously in March in 1991’.

The presentation committee of the Winter Olympics in Nagano was founded as a voluntary association in October, 1989. The governor of Nagano, Mr. Yoshimura, was inaugurated as Chairman. The Olympiad in Tokyo and the Winter Olympics in Sapporo were the national projects, but the Olympiad in Nagano took the presentation activities led by the Prefecture and the City with the significance of independent municipality. According to the roll, 90% of the 51 members of the office were staffs of the Nagano prefecture, the city, and the related towns and villages. Mr. Yoshimura, the governor of the Prefecture, denied the request to Yokakai to offer the donations.

According to the donor list acquired by the Mainichi Daily News, the donors are listed by business type as per attached table. Among the construction and civil engineering companies, each of the twelve general contractors offered 10 million yen, and others offered 20 million, 5 million, 1.5 million respectively. A total of 600 or more construction, civil engineering, and construction material handling companies made contributions. The donations from the business and industries were offered through the Japan Amateur Athletic Association which is a specific public service corporation on the tax-free basis.

On the other hand, considering the relationship between the reception of orders and the donors concerned with the constructions of the facilities of the Olympic Games, the general contractors which received the orders and made the respective contracts for the facilities of figure skating, speed skating, ice hockey, bobsledding, luge, jumping, the main constructions of the opening and ending ceremony facilities, etc. offered donations of several million to ten million yen. A large communications equipment manufacturer offered as much as ten million yen which doubled the amount of the donations of other companies belonging to the same industry who offered about three to five million yen. In 1989 to 1992, this manufacturer received the order of the construction for nonflammable-type wireless digitized system of about a total of 3 billion yen which was a conspicuously large amount over the others'. <<The committee stated its activity funds of about 2.17 billion yen as income (601 million yen from the Prefecture, 230 million yen as a share from related cities, towns, and villages, 1.08 billion yen as donations from various companies, etc.) and about 1.96 billion yen as expenditures (the breakdown of 5 items including the advertising cost, etc.), and set the rest off the record.>>

# Huge Volume of Reports and Simple Explanation of Costs #

In June, 1991, the IOC General Conference in Birmingham decided the Olympiad in Nagano to be held as the 18th Winter Olympiad (in February, 1998) by rejecting four other cities including Salt Lake City of the USA. The presentation committee contributed the surplus of about 200 million yen to the Olympic Games Organization Committee in Nagano, and was dismissed in October, 1991 with a huge volume of presentation reports of 268 pages. However, the important cost for the presentation is explained on five pages only including a simple settling report followed by the ‘fund-raising records’ with the figures of about 1 billion yen and the number related companies, which is too little information about the report from the Prefecture to the citizens.

The year of 1995 has started after a half-century from the end of the World War II. The decentralization promotive law is taken up to the session of the Diet, and the nationwide local elections are called this year. The communalism is to be fundamentally reconsidered, and a new guide to what it ought to be should be proposed. In Part I of the ‘Islandlogy’ for consideration of communalism, the situation of ‘Your Town’ and the problems of the waste of tax, the closed information, etc. are checked from the viewpoint of a habitants and a taxpayer.

# Amounts of Donations by
Business Type (compiled by Mainichi Daily News) #

| Construction (general contractor, construction, bridges, | approx. |
|---|---|
| etc.) | 330 million yen |
| Development, real estate, housing | 74 |
| Banks, securities firms | 53 |
| Food-products companies | 42 |
| Computer, communications | 34 |
| Large electric facilities | 32 |
| Automobile industry | 26 |
| Electric appliance | 13 |
| Companies owned by habitants of Nagano Prefecture | 76″ |

### OUTPUT EXAMPLE 2

<<<<<Islandlogy>>>>> In your>>>> <<Town>> <<<</1>>>> <<<<List of <<<<Donor Companies>>>> Found>>>>—<<<<Presentation Committee for Olympiad>>>> <<<<in Nagano>>>>

# Receives Orders of Constructions After <<Donations>> <<->> Information to be on Public View #

Due to the lost bookkeeping information, details of a large amount of activity funds of the <<<<presentation committee>>>> for the Olympiad in <<Nagano>> have been unclear. The Mainichi Daily News acquired on the 31st the ‘<<list>> of the <<companies>> and the amounts’ indicating the breakdown of the <<<<donations>>>> to the official organizations most of which are managed by the staffers on loan of the Prefecture and the City. Of the <<<<donations>>>> of about ten billion yen, the majority of them amounting to about 330 million yen were offered by the construction industry including the general contractors. Most of the <<companies>> received the orders of the <<Olympic game>> facilities and the civil engineering works after the donations. The <<<<presentation committee>>>> kept the names of the <<companies>> off the record for the reason of the privacy protection of the <<donors>>, but the <<list>> implies the ‘cozy relationship’ between the municipalities having the rights of placing the orders and the donor <<companies>>. On the other hand, the donations were spent as enormous amounts of money of 200 million yen on entertainment of the International Olympic Committee (IOC) and advertising videos. The gigantic event of the municipalities which control and manage taxes and tax-free <<donations>> is requested to be on public view (related articles on the city news page).

In the conference room on the eighth floor of the City Hall of <<Nagano>> where the Office of the <<presentation>> committee is located, some concerned members including the staffs of <<Nagano>> Prefecture and City, the local business leaders, etc. were summoned in April, 1990. ‘The <<funds>> are raised for the purposes . . . ’

The leaders of the prefecture distributed the copies of the explanation to the participants. The sheet indicating the name of the <<<<presentation committee>>>> as the notes written in the margin read ‘Preparatory Plan for Funds’ including the items of ‘spending’, ‘income’, ‘deficits in budgets’, etc. with the respective amounts. The outstanding item was ‘Assignment of funds for deficits’ for ‘Yokakai 200’. The unit was a million yen, that is, a total of 200 million yen was assigned to Yokakai.

Yokakai was a friendly party formed by 38 companies including large general contractors, etc. from other prefectures. One of those concerned with the construction industry said, ‘Practically, it was an organization of cozy relationship for controlling the orders of the constructions placed by the Prefecture’. The party was dismissed in the year before last in which the scandal of the general contractors occurred. An executive of a general contractor which offered the donations testified, ‘In July, 1990 (three months after the conference), one of the leaders of the prefecture requested Yokakai to offer the donations. Most of the companies offered the donations simultaneously in March in 1991’.

The <<presentation>> committee of the Winter Olympics in<<Nagano>> was founded as a voluntary association in October, 1989. The governor of <<Nagano>>, Mr. Yoshimura, was inaugurated as Chairman. The <<Olympiad>> in Tokyo and the Winter Olympics in Sapporo were the national projects, but the Olympiad in<<Nagano>> took the <<presentation>> activities led by the Prefecture and the City with the significance of independent municipality. According to the roll, 90% of the 51 members of the office were staffs of the <<Nagano>> prefecture, the city, and the related towns and villages. Mr. Yoshimura, the governor of the Prefecture, denied the request to Yokakai to offer the <<donations>>.

According to the <<<<donor list>>>> acquired by the Mainichi Daily News, the donors are listed by business type as per attached table. Among the construction and civil engineering companies, each of the twelve general contractors offered 10 million yen, and others offered 20 million, 5 million, 1.5 million respectively. A total of 600 or more construction, civil engineering, and construction material handling companies made <<contributions>>. The <<donations>> from the business and industries were offered through the Japan Amateur Athletic Association which is a specific public service corporation on the tax-free basis.

On the other hand, considering the relationship between the reception of orders and the <<donors>> concerned with the constructions of the facilities of the <<Olympic Games>>, the general contractors which received the orders and made the respective contracts for the facilities of figure skating, speed skating, ice hockey, bobsledding, luge, jumping, the main constructions of the opening and ending ceremony facilities, etc. offered <<donations>> of several million to ten million yen. A large communications equipment manufacturer <<offered>> as much as ten million yen which doubled the amount of the donations of other companies belonging to the same industry who <<offered>> about three to five million yen. In 1989 to 1992, this manufacturer received the order of the construction for nonflammable-type wireless digitized system of about a total of 3 billion yen which was a conspicuously large amount over the others.

<<The committee stated its activity funds of about 2.17 billion yen as income (601 million <<yen>> from the Prefecture, 230 million yen as a <<share>> from related cities, towns, and villages, 1.8 billion yen as<<<<donations>>>> from various companies, etc.) and about 1.96 billion yen as expenditures (the breakdown of 5 items including the advertising cost, etc.), and set the rest off the record.>>

# Huge Volume of Reports and Simple Explanation of Costs #

In June, 1991, the IOC General Conference in Birmingham decided the <<<<Olympiad in Nagano>>>> to be held as the 18th Winter Olympiad (in February, 1998) by rejecting four other cities including Salt Lake City of the USA. The <<<<presentation committee>>>> contributed the <<surplus>> of about 200 million yen to the <<<<Olympic Games>>>> Organization Committee in <<<<Nagano>>>>, and was dismissed in October, 1991 with a huge volume of <<presentation>> reports of 268 pages. However, the important cost for the <<presentation>> is explained on five pages only including a simple settling report followed by the ‘fund-raising records’ with the figures of about 1 billion yen and the number related <<companies>>, which is too little information about the report from the Prefecture to the citizens.

The year of 1995 has started after a half-century from the end of the World War II. The decentralization promotive law is taken up to the session of the Diet, and the nationwide local elections are called this year. The communalism is to be fundamentally reconsidered, and a new guide to what it ought to be should be proposed. In Part I of the ‘<<<<Islandlogy>>>>’ for consideration of communalism, the situation of ‘<<Your>> <<Town>>’ and the problems of the waste of tax, the closed information, etc. are checked from the viewpoint of a habitants and a taxpayer.

# Amounts of <<Donations>> by
Business Type (compiled by Mainichi Daily News) #

| | |
|---|---|
| Construction (general contractor, construction, bridges, | approx. |
| etc.) | 330 million yen |
| Development, real estate, housing | 74 |
| Banks, securities firms | 53 |
| Food-products companies | 42 |
| Computer, communications | 34 |
| Large electric facilities | 32 |
| Automobile industry | 26 |
| Electric appliance | 13 |
| Companies owned by habitants of <<Nagano>> | 76″ |
| Prefecture | |

In this case, the output example can be more easily read. For example, according to the <<<<donor list>>>> acquired by the Mainichi Daily News in the middle of the text above, the sentence of “the donors are listed by business type as per attached table. Among the construction and . . . ” indicates that the important “donor list” is described around here and that an attached list is available.

The “donations”, “presentation committee”, “Olympiad in Nagano” and the like are specifically highlighted, and the interesting word “Islandlogy” is also specifically highlighted. Therefore, a reader who is anxious to know what is the title “Islandlogy” can be well informed of the specifically highlighted term.

Described below is an example of the case in which an area specified by a user is used.

When the position of an extraction area is determined in advance, an area specified by a user is defined as an extraction area. An area specified by a user by, for example, inverting an area using a mouse dragging operation, is recognized as an inverted portion. When two words to be highlighted are consecutive, the portion is specifically highlighted.

### INPUT EXAMPLE 1

### A Case of a Patent Document>

“{claim 1} A weeding sickle having an edge portion at an end of an edge member formed roughly and in a wave shape and spirally curved with a handle attached to the edge member.

{claim 2} A weeding sickle comprising non-slip portions at an upper portion and a lower portion of the handle.

(omitted)

The present invention is described below in detail by referring to the attached drawings. FIG. 1 is a front view of the weeding sickle according to the present invention; FIG. 2 is a back view of the weeding sickle according to the present invention; and FIG. 3 is a right side view of the weeding sickle according to the present invention.

As shown in FIG. 3, a weeding sickle 1 comprises: an edge member 2 having an edge portion 2b one side of whose end is formed wavy as a wavy edge 5, and the back side is formed flat; and a handle 3.

As shown in FIGS. 1, 2, and 3, the edge member 2 has an extension portion 2a having a double length of the handle 3. The edge portion 2b of the wavy edge 5 is curved in one direction.

FIG. 4 is an enlarged front view of the edge portion of the weeding sickle according to the present invention. As shown in FIG. 4, the edge portion 2b for shearing weeds is wavy shaped alternately having extending portions 5a and receding portions 5b.

FIG. 5 is an enlarged view of the edge portion of the weeding sickle according to the present invention. The tip of the extending portion 5a forming the edge portion 2b is slanted somewhat to the left so that weeds can be easily picked and sheared.

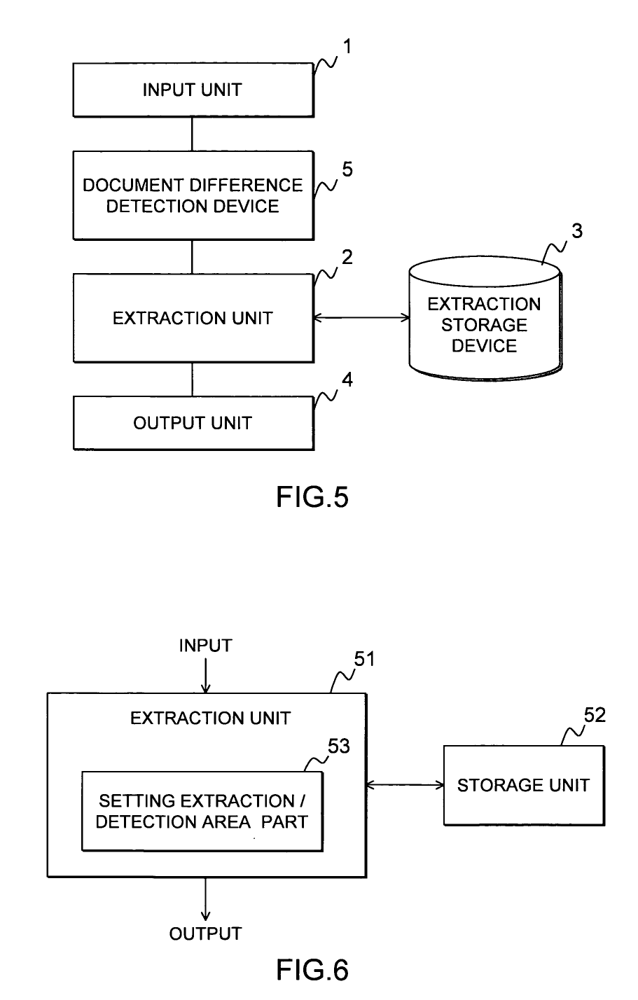

FIG. 6 is a partially enlarged view showing the curved state of the edge portion of the weeding sickle according to the present invention. As shown in FIG. 6, a tip 2c of the edge portion 2b is curved over a vertical line 6 more than the extension portion 2a of the edge portion 2b.

FIG. 7 is a sectional view along the line A-A. An upper surface 7 of the edge portion 2b is slanted, and a peak 5c of the extending portion 5a is acute. The edge portion 2b is spirally curved.

FIG. 8 is a front view according to another embodiment of the weeding sickle of the present invention; FIG. 9 is a back view of another embodiment of the weeding sickle of the present invention; FIG. 10 is a right side view according to another embodiment of the weeding sickle of the present invention; and FIG. 11 is a partially enlarged view according to another embodiment of the weeding sickle of the present invention.

The weeding sickle 1a according to the present invention has a short extension portion 2a of the edge member 2 and the edge portion 2b formed somewhat big.

The handle 3 is long. An upper non-slip portion 3a, arranged on a grip portion 3b, has a diameter a little larger than that of the grip portion 3b. A lower non-slip portion 3cb is also arranged to have a diameter larger than that of the grip portion 3b.

As shown in FIG. 10, the edge portion 2b of the weeding sickle 1a according to the present invention is also spirally curved like the weeding sickle 1 shown in FIGS. 1 to 7.

As described above, the weeds on the lawn can be easily removed from the roots by the end portion spirally curved.”

In the input example, assume that the user has area-specified only the portion “comprising non-slip portions at an upper portion and a lower portion” in the text of {claim 2}. Then, the following result is obtained.

### OUTPUT EXAMPLE 1

“{claim 1} A weeding sickle having an edge <<portion>> at an end of an edge member formed roughly and in a wave shape and spirally curved with a <<handle>> attached to the edge member.

{claim 2} A weeding sickle <<comprising>> <<non-slip portions>> at an<<upper portion and a lower portion>> of the <<handle>>.

(omitted)

The present invention is described below in detail by referring to the attached drawings. FIG. 1 is a front view of the weeding sickle according to the present invention; FIG. 2 is a back view of the weeding sickle according to the present invention; and FIG. 3 is a right side view of the weeding sickle according to the present invention.

As shown in FIG. 3, a weeding sickle 1 comprises: an edge member 2 having an edge <<portion>> 2b one side of whose end is formed wavy as a wavy edge 5, and the back side is formed flat; and a <<handle>> 3.

As shown in FIGS. 1, 2, <<and>> 3, the edge member 2 has an extension <<portion>> 2a having a double length of the <<handle>> 3. The edge <<portion>> 2b of the wavy edge 5 is curved in one direction.

FIG. 4 is an enlarged front view of the edge <<portion>> of the weeding sickle according to the present invention. As shown in FIG. 4, the edge <<portion>> 2b for shearing weeds is wavy shaped alternately having extending <<portions>> 5a and receding <<portions>> 5b.

FIG. 5 is an enlarged view of the edge <<portion>> of the weeding sickle according to the present invention. The tip of the extending <<portion>> 5a forming the edge <<portion>> 2b is slanted somewhat to the left so that weeds can be easily picked and sheared.

FIG. 6 is a partially enlarged view showing the curved state of the edge <<portion>> of the weeding sickle according to the present invention. As shown in FIG. 6, a tip 2c of the edge <<portion>> 2b is curved over a vertical line 6 more than the extension <<portion>> 2a of the edge <<portion>> 2b.

FIG. 7 is a sectional view along the line A-A. An upper surface 7 of the edge <<portion>> 2b is slanted, and a peak 5c of the extending <<portion>> 5a is acute. The edge <<portion>> 2b is spirally curved.

FIG. 8 is a front view according to another embodiment of the weeding sickle of the present invention; FIG. 9 is a back view of another embodiment of the weeding sickle of the present invention; FIG. 10 is a right side view according to another embodiment of the weeding sickle of the present invention; and FIG. 11 is a partially enlarged view according to another embodiment of the weeding sickle of the present invention.

The weeding sickle 1a according to the present invention has a short extension <<portion>> 2a of the edge member 2 and the edge <<portion>> 2b formed somewhat big.

The <<handle>> 3 is long. An upper <<<<non->>>> slip <<<<portion>>>> 3a, arranged on a grip <<portion>> 3b, has a diameter a little larger than that of the grip <<portion>> 3b. A lower <<<<non-slip portion>>>> 3cb is also <<arranged>> to have a diameter larger than that of the grip <<portion>> 3b.

As shown in FIG. 10, the edge <<portion>> 2b of the weeding sickle 1a according to the present invention is also spirally curved like the weeding sickle 1 shown in FIGS. 1 to 7.

As described above, the weeds on the lawn can be easily removed from the roots by the end <<portion>> spirally curved.”

In the example of the patent document, a specifically highlighted portion is first located in {claim 2}. Then, the paragraph {0015} attracts attention. Thus, it is apparent that the contents relating to {claim 2} are described in the paragraph {0015}. When the claims of the patent document are read, a reader often requests to the corresponding embodiment. According to the present invention, the request can be easily accepted. In the “upper non-slip portion”, only the “non” is highlighted. The morpheme analysis system mis-analyzed the upper non-slip unit as non-upper-slip unit.

Described below is an example of using a document difference detection device.

FIG. 5 shows an example configuration of the keyword highlighting apparatus using the document difference detection device. In FIG. 5, the keyword highlighting apparatus comprises an input means 1, an extraction means 2, an extraction storage device 3, an output means 4, and a document difference detection device 5. The input means 1 can be a keyboard, a mouse, a reader, etc. and inputs information. The extraction means 2 extracts a difference between input documents. The extraction storage device 3 stores extraction such as a word, a kanji character, a noun phrase, etc. The output means 4 can be a display device, a printer, etc. and outputs information. The document difference detection device 5 highlights a first character string of the input text.

FIG. 6 shows an example configuration of the document difference detection device. In FIG. 6, the document difference detection device comprises an extraction means 51 and a storage means 52. The extraction means 51 comprises an extraction/detection area setting means 53. The extraction means 51 extracts the difference between input documents. The storage means 52 stores extraction such as a word, a kanji character, a noun phrase, etc. The extraction/detection area setting means 53 sets a unit of extraction (extraction unit) and a unit of a detection area.

The extraction means 2 can be used as the extraction means 51, and the extraction storage device 3 can be used as the storage means 52.

The method of determining the first character string in the input text to be highlighted using the document difference detection device can be the following methods 1 and 2 (q.v. Japanese Patent Application No. 2002-290946).

(a) Method 1

S1: The input unit 1 determines a unit of extraction (extraction unit) and a unit of detection area in advance. The extraction unit refers to a unit to be output as a difference. The extraction unit can be a “word”, a “kanji character”, a “noun phrase” or the like. The detection area refers to a unit of an area to be compared for detection of a difference. The unit of a detection area can be a “character”, a “word”, “text”, a ‘item’!, a “paragraph”, a “claim of patent” or the like.

S2: The extraction means 51 stores all input data in storage means (in the extraction means 51).

S3: The extraction means 51 checks the input data from the left, and repeats the processes S4 and S5 for each detection area determined in the process S1 from the left detection area.

S4: The extraction means 51 extracts equivalents (for example, words) of all extraction units from the areas other than the current detection area, and stores them in the storage means 52.

S5: The extraction means 51 highlights an equivalent (for example, a word) of an extraction unit not stored in the storage means 52 in the current detection area, and outputs the text of the current detection area.

(b) Method 2

S1: The input unit 1 determines a unit of extraction (extraction unit) and a unit of detection area in advance. The extraction unit refers to a unit to be output as a difference. The extraction unit can be a “word”, a “kanji character”, a “noun phrase” or the like. The detection area refers to a unit of an area to be compared for detection of a difference. The unit of a detection area can be a “character”, a “word”, “text”, a “item”, a “paragraph”, a “claim of patent” or the like.

S2: The input unit 1 inputs input data for each detection area determined in the process S1, and the extraction means 51 repeats the following processes S3 and S4.

S3: The extraction means 51 highlights an equivalent (for example, a word) of an extraction unit not stored in the storage means 52, and outputs the text of the current detection area. However, the storage means 52 is first blank.

S4: The expression highlighted in the process S1 is stored in the storage means 52.

Specific examples are shown below.

For an example 1 of the method 1, it is assumed that an output result of the method 1 using the document difference detection device on a patent document is described below.

“{claim 1} A weeding sickle having an<<edge portion>> at an<<end>> of an<<edge member>> <<formed>> <<roughly>> and <<in a wave shape>> and <<spirally>> <<curved>> with a handle <<attached>> to the <<edge member>>.

{claim 2} A weeding sickle <<comprising>> <<non-slip>> portions at an<<upper portion and a lower portion>> of the handle.”

The words appearing only in claim 1 or 2 are highlighted (enclosed by chevrons). On the other hand, for example, assume that a user has specified the area only for claim 2 as a user specified area.

“{claim 2} A weeding sickle <<comprising>> <<non-slip>> portions at an<<upper portion and a lower portion>> of the handle.”

Then, the extraction means 2 determines only the “upper portion and a lower portion”, “non-slip”, and “comprising” as the user specified areas where the portions highlighted by the document difference detection device overlap the specified areas, and uses the same algorithm.

### OUTPUT EXAMPLE 1

“{claim 1} A weeding sickle having an edge portion at an end of an edge member formed roughly and in a wave shape and spirally curved with a handle attached to the edge member.

{claim 2} A weeding sickle <<comprising>> <<<<non-slip>>>> portions at an <<<<upper portion and a lower portion>>>> of the handle.

(omitted)

The present invention is described below in detail by referring to the attached drawings. FIG. 1 is a front view of the weeding sickle according to the present invention; FIG. 2 is a back view of the weeding sickle according to the present invention; and FIG. 3 is a right side view of the weeding sickle according to the present invention.

As shown in FIG. 3, a weeding sickle 1 comprises: an edge member 2 having an edge portion 2b one side of whose end is formed wavy as a wavy edge 5, and the back side is formed flat; and a handle 3.

As shown in FIGS. 1, 2, and 3, the edge member 2 has an extension portion 2a having a double length of the handle 3. The edge portion 2b of the wavy edge 5 is curved in one direction.

FIG. 4 is an enlarged front view of the edge portion of the weeding sickle according to the present invention. As shown in FIG. 4, the edge portion 2b for shearing weeds is wavy shaped alternately having extending portions 5a and receding portions 5b.

FIG. 5 is an enlarged view of the edge portion of the weeding sickle according to the present invention. The tip of the extending portion 5a forming the edge portion 2b is slanted somewhat to the left so that weeds can be easily picked and sheared.

FIG. 6 is a partially enlarged view showing the curved state of the edge portion of the weeding sickle according to the present invention. As shown in FIG. 6, a tip 2c of the edge portion 2b is curved over a vertical line 6 more than the extension portion 2a of the edge portion 2b.

FIG. 7 is a sectional view along the line A-A. An upper surface 7 of the edge portion 2b is slanted, and a peak 5c of the extending portion 5a is acute. The edge portion 2b is spirally curved.

FIG. 8 is a front view according to another embodiment of the weeding sickle of the present invention; FIG. 9 is a back view of another embodiment of the weeding sickle of the present invention; FIG. 10 is a right side view according to another embodiment of the weeding sickle of the present invention; and FIG. 11 is a partially enlarged view according to another embodiment of the weeding sickle of the present invention.

The weeding sickle 1a according to the present invention has a short extension portion 2a of the edge member 2 and the edge portion 2b formed somewhat big.

The handle 3 is long. An upper <<non>>-slip portion 3a, arranged on a grip portion 3b, has a diameter a little larger than that of the grip portion 3b. A lower <<<<non-slip>>>> portion 3cb is also <<arranged>> to have a diameter larger than that of the grip portion 3b.

As shown in FIG. 10, the edge portion 2b of the weeding sickle 1a according to the present invention is also spirally curved like the weeding sickle 1 shown in FIGS. 1 to 7.

As described above, the weeds on the lawn can be easily removed from the roots by the end portion spirally curved.”

In the output example, the paragraph 0015 is more apparent than the portion corresponding to claim 2.

For an example 2 of the method 1, it is assumed that an output result of the method 1 using the document difference detection device on a patent document is described below.

“{claim 1} A weeding sickle having an<<edge portion>> at an<<end>> of an<<edge member>> <<formed>> <<roughly>> and <<in a wave shape>> and <<spirally>> <<curved>> with a handle <<attached>> to the <<edge member>>.

{claim 2} A weeding sickle <<comprising>> <<non-slip>> portions at an<<upper portion and a lower portion>> of the handle.”

The words appearing only in claim 1 or 2 are highlighted (enclosed by chevrons). On the other hand, for example, assume that a user has specified the two areas (specified areas 1 and 2) only for claims 1 and 2 as a user specified area.

<Specified Area 1>

“{claim 1} A weeding sickle having an<<edge portion>> at an<<end>> of an<<edge member>> <<formed>> <<roughly>> and <<in a wave shape>> and <<spirally>> <<curved>> with a handle <<attached>> to the <<edge member>>. <specified area 2>

“{claim 2} A weeding sickle <<comprising>> <<non-slip>> portions at an <<upper portion and a lower portion>> of the handle.”

Then, the extraction means 2 determines only the “edge portion”, “end”, “edge member”, “formed”, “roughly, “in a wave shape”, “spirally”, “curved”, “attached”, and “edge member” of the specified areas 1, and “comprising”, “non-slip”, and “upper portion and a lower portion” of the specified area 2 for which the portions highlighted by the document difference detection device overlap the specified areas as the user specified areas, and uses the same algorithm.

Keywords of the specified areas 1 and 2 are differently highligheted.

<Output example of difference highlight depending on specified area>

“{claim 1} A weeding sickle having an<<edge>> portion at an<<end>> of an<<<<edge member>>>> <<<<formed>>>> <<roughly>> and <<<<in a wave shape>>>> and <<<<spirally>>>> <<<<curved>>>> with a handle <<attached>> to the <<<<edge member>>>>.

{claim 2} A weeding sickle <comprising> <<non-slip>> portions at an<<upper portion and a lower portion>> of the handle.

(omitted)

The present invention is described below in detail by referr<<ing>> to the attached drawings. FIG. 1 is a front view of the weeding sickle according to the present invention<<;>> FIG. 2 is a back view of the weeding sickle according to the present invention<<;>> and FIG. 3 is a right side view of the weeding sickle according to the present invention.

As shown in FIG. 3<<,>> a weeding sickle 1 comprises: an<<<<edge member>>>> 2 having an<<edge>> portion 2b one side of whose <<end>> is <<<<formed>>>> <<wavy>> as a <<<<wavy edge>>>> 5, and the back side is <<<<formed>>>> flat<<;>> and a handle 3.

As shown in FIG. 1<<,>> 2, <and> 3<<,>> the <<<<edge member>>>> 2 has an extension portion 2a having a double leng<<th>> of the handle 3. The <<edge>> portion 2b of the <<<<wavy edge>>>> 5 is <<<<curved>>>> in one direction.

FIG. 4 is an enlarged front view of the <<edge>> portion of the weeding sickle according to the present invention. As shown in FIG. 4<<,>> the <<edge>> portion 2b for shearing weeds is <<<<wavy>>>> shaped alternately having extending portions 5a and receding portions 5b.

FIG. 5 is an enlarged view of the <<edge>> portion of the weeding sickle according to the present invention. The <<tip>> of the extending portion 5a forming the <<edge>> portion 2b is slanted somewhat to the left so that weeds can be easily picked and sheared.

FIG. 6 is a partially enlarged view showing the <<curved>> state of the <<edge>> portion of the weeding sickle according to the present invention. As shown in FIG. 6<<,>> a <<tip>> 2c of the <<<<edge>>>> portion 2b is <<<<curved>>>> over a vertical line 6 more than the extension portion 2a of the edge portion 2b.

FIG. 7 is a sectional view along the line A-A. An upper surface 7 of the <<edge>> portion 2b is slanted<<<<,>>>> and a <<peak>> 5c of the extending portion 5a is acute. The <<<<edge>>>> portion 2b is <<<<spirally>>>><<curved>>.

FIG. 8 is a front view according to another embodiment of the weeding sickle of the present invention<<;>> FIG. 9 is a back view of another embodiment of the weeding sickle of the present invention<<;>> FIG. 10 is a right side view according to another embodiment of the weeding sickle of the present invention<<;>> and FIG. 11 is a partially enlarged view according to another embodiment of the weeding sickle of the present invention.

The weeding sickle 1a according to the present invention has a short extension portion 2a of the <<<<edge member>>>>2 and the <<edge>> portion 2b <<<<formed>>>> somewhat big.

The handle 3 is long. An upper <non>-slip portion 3a, arranged on a grip portion 3b, has a diameter a little larger than that of the grip portion 3b. A lower <<non-slip>> portion 3cb is also arranged to have a diameter larger than that of the grip portion 3b.

As shown in FIG. 10<<,>> the <<edge>> portion 2b of the weeding sickle 1a according to the present invention is also <<<<spirally>>>> <<<<curved>>>> like the weeding sickle 1 shown in FIGS. 1 to 7.

As described above, the weeds on the lawn can be easily removed from the roots by the <<<<end>>>> portion <<<<spirally>>>> <<<<curved>>>>.”

In the output example above, the keywords obtained in claim 1 are highlighted by “<<” and “>>” (double chevrons), the keywords obtained in claim 2 are highlighted by “<” and “>” (chevrons), and each highlight expressions are collectively displayed.

In this output example, what are related to claim 1 appear in the entire text, and what are related to claim 2 appear in the paragraph 0015. It is convenient that the information can be simultaneously informed.

In the example above, two areas, that is, the specified areas 1 and 2, can be specified. However, three or more areas can be specified. Furthermore, a highlighted portion can be expressed by an underline, different colors, an inverted background, variations of fonts, blinking display, etc. in addition to the double chevrons.

Described below is to install a program.

The input means 1, extraction means 2, extraction storage device 3, storage means 3a and 52, output means 4, document difference detection device 5, extraction unit setting means 21, extraction expression setting means 22, extraction area setting means 23, extraction/detection area setting means 53, etc. can be configured by a program, executed by a main control unit (CPU), and stored in main memory. The program is processed in a common computer. The computer is configured by hardware such as a main control unit, main memory, a file device, a display device, an input device which is input means such as a keyboard, etc. The program of the present invention is installed on the computer by storing the program on a portable recording (storage) medium such as a flexible disk, a magneto-optical disk, etc., and installing it on the file device provided for the computer through a drive device for access to the storage medium of the computer or through a network such as a LAN, etc. Then, a necessary program step is read to the main memory from the file device, and the main control unit executes each program step.

As described above, the present invention has the following effects.

1) The extraction means extracts an equivalent of the extraction unit from the extraction area, stores an equivalent of the extraction expression in the storage means, and highlights an equivalent of the current extraction unit if it is stored in the storage means after checking the input data from the left. Therefore, the position corresponding to the explanation of the extraction area can be easily detected in the input data.

2) The input data is checked from the left. If an equivalent of the current extraction unit is stored in the storage means, and if the extraction unit which is one unit before the current extraction unit is to be highlighted, then the extraction unit which is one unit before the current extraction unit and the current extraction unit are specifically highlighted. Therefore, the position explained as an extraction area can be more clearly detected in the input data.

3) At least one of the settings of extraction expressions for highlight by the extraction expression setting means is a noun. Therefore, only important portions such as a noun, etc. can be highlighted.

4) The position of an extraction area is a title portion of the input data. Therefore, the position explained as a title portion to be an important data can be easily detected in the input data.

5) The position of an extraction area is a portion specified by a user in the input data. Therefore, the position explained as the portion specified by a user can be easily detected in the input data.

6) A plurality of portions are specified as the portions specified by a user, and differently highlighted depending on the specified portions. Therefore, the positions explained as a plurality of portions specified by the user can be easily detected in the input data.

7) A document difference detection device highlights an equivalent of the extraction unit first detected in the input data. A portion highlighted by the document difference detection device as a portion specified by a user is specified. Therefore, the position explained as a portion specified by a user can be more clearly detected in the input data.

8) A document difference detection device sets a detection area which is an area unit for comparison in detecting a difference between input data, extracts equivalents of all extraction units from an area other than the current detection area of the input data, and highlights an equivalent of an extraction unit not detected in the area other than the detection area. A portion highlighted by the document difference detection device is specified as a portion specified by a user. Therefore, a position explained as a portion specified by the user can be more clearly detected in the input data.

9) Without using extraction expression setting means, the extraction means defines the portion highlighted by the document difference detection device as the position of the extraction area, extracts an equivalent of the extraction unit from the extraction area and stores it in the storage means, checks the input data from the left, and highlights an equivalent of the current extraction unit if it is stored in the storage means. Therefore, the position explained as the position corresponding to an extraction unit such as a word, etc. first detected in the input data can be easily and clearly detected.

10) Without using extraction expression setting means, a document difference detection device sets a detection area which is an area unit for comparison in detecting the difference between the input data, extracts equivalents of all extraction units from the area other than the current detection area of the input data, and highlights an equivalent of the extraction unit not in the area other than the detection area. The extraction means defines the portion highlighted by the document difference detection device as the position of the extraction area, extracts an equivalent of the extraction unit from the extraction area and stores it in the storage means, checks the input data from the left, and highlights an equivalent of the current extraction unit if it is stored in the storage means. Therefore, the position explained as the position corresponding to an extraction unit such as a word, etc. first detected in the input data can be easily and clearly detected.

11) A program or a computer-readable storage medium storing the program executed by a computer is realized as extraction unit setting means for setting an extraction unit; extraction expression setting means for setting an extraction expression for a highlight; extraction area setting means for setting the position of an extraction area; and extraction means for extracting an equivalent of the extraction unit from the extraction area, storing an equivalent of the extraction expression in the storage means, and highlighting an equivalent of the current extraction unit if it is stored in the storage means after checking the input data from the left. Therefore, a keyword highlighting apparatus capable of easily detecting the position corresponding to the explanation of the extraction area in the input data can be easily provided by installing the program in the computer.

12) A program or a computer-readable storage medium storing the program executed by a computer is realized as extraction unit setting means for setting an extraction unit; extraction expression setting means for setting an extraction expression for a highlight; document difference detection means for highlighting an equivalent of the extraction unit first detected in input data; extraction area setting means for setting a portion highlighted by the document difference detection means as the position of an extraction area; and extraction means for extracting an equivalent of the extraction unit from the extraction area, storing an equivalent of the extraction expression in the storage means, and highlighting an equivalent of the current extraction unit if it is stored in the storage means after checking the input data from the left. Therefore, a keyword highlighting apparatus capable of more clearly detecting the position corresponding to the explanation of the portion specified by a user in the input data can be easily provided by installing the program in the computer.

13) A program or a computer-readable storage medium storing the program executed by a computer is realized as extraction unit setting means for setting an extraction unit; extraction area setting means for setting the position of an extraction area; document difference detection means for highlighting an equivalent of the extraction unit first detected in input data; and extraction means for defining a portion highlighted by the document difference detection means as the position of the extraction area, extracting an equivalent of the extraction unit from the extraction area and storing it in the storage means, and highlighting an equivalent of the current extraction unit if it is stored in the storage means after checking the input data from the left. Therefore, a keyword highlighting apparatus capable of more clearly detecting the position corresponding to the explanation of the portion corresponding to the extraction unit first detected in the input data can be easily provided by installing the program in the computer.

What is claimed is:

1. An apparatus for keyword highlighting, comprising:
extraction unit setting means for setting an extraction unit;
extraction expression setting means for setting an extraction expression for a highlight;
extraction area setting means for setting a position of an extraction area;
storage means for storing information; and
extraction means for extracting an equivalent of the extraction unit from the extraction area, storing an equivalent of the extraction expression in the storage means, and highlighting an equivalent of the current extraction unit if it is stored in the storage means after checking input data from left.

2. The apparatus according to claim 1, wherein
the input data is checked from the left, and an extraction unit proximate to the current extraction unit and the current extraction unit are specifically highlighted when an equivalent of the current extraction unit is stored in the storage means and the extraction unit proximate to the current extraction unit is set to be highlighted.

3. The apparatus according to claim 1, wherein
at least one of settings of extraction expressions for highlight by the extraction expression setting means is a noun.

4. The apparatus according to claim 1, wherein
a position of the extraction area is a title portion of the input data.

5. The apparatus according to claim 1, wherein
a position of the extraction area is a portion specified by a user in the input data.

6. The apparatus according to claim 5, wherein
a plurality of portions are specified as portions specified by a user, and each of the specified portions is differently highlighted.

7. The apparatus according to claim 5, further comprising
a document difference detection device for highlighting an equivalent of the extraction unit first detected in the input data, wherein
a portion highlighted by the document difference detection device is specified as a portion specified by the user.

8. The keyword highlighting apparatus according to claim 5, further comprising
a document difference detection device for setting a detection area which is an area unit for comparison in detecting a difference between input data, extracting equivalents of all extraction units from an area other than the current detection area of the input data, and highlighting an equivalent of the extraction unit not detected in the area other than the detection area, wherein
a portion highlighted by the document difference detection device is specified as a portion specified by the user.

9. An apparatus for keyword highlighting, comprising:
extraction unit setting means for setting an extraction unit;
extraction area setting means for setting a position of an extraction area;
storage means for storing information;
extraction means; and
a document difference detection device for highlighting an equivalent of the extraction unit first detected in input data, wherein
the extraction means defines the portion highlighted by the document difference detection device as a position of the extraction area, extracts an equivalent of the extraction unit from the extraction area and stores the equivalent in the storage means, checks the input data from the left, and highlights an equivalent of a current extraction unit when stored in the storage means.

10. An apparatus for keyword highlighting, comprising:
extraction unit setting means for setting an extraction unit;
extraction area setting means for setting a position of an extraction area;
storage means for storing information;
extraction means; and
a document difference detection device for setting a detection area which is an area unit for comparison in detecting a difference between input data, extracting equivalents of all extraction units from an area other than the current detection area of the input data, and highlighting an equivalent of the extraction unit not in an area other than the detection area, wherein
the extraction means defines the portion highlighted by the document difference detection device as a position of the extraction area, extracts an equivalent of the extraction unit from the extraction area and stores the equivalent in the storage means, checks the input data from the left, and highlights an equivalent of the current extraction unit when stored in the storage means.

11. A computer program for keyword highlighting processing, the program causing a computer to execute:
extraction unit setting processing for setting an extraction unit;
extraction expression setting processing for setting an extraction expression for a highlight;
extraction area setting processing for setting a position of an extraction area; and
extraction processing for extracting an equivalent of the extraction unit from the extraction area, storing an equivalent of the extraction expression in the storage means, and highlighting an equivalent of a current extraction unit when stored in the storage means after checking input data from the left.

12. A computer program for keyword highlighting processing, the program causing a computer to execute:
extraction unit setting processing for setting an extraction unit;
extraction expression setting processing for setting an extraction expression for a highlight;
document difference detection processing for highlighting an equivalent of the extraction unit first detected in input data;
extraction area setting processing for setting the portion highlighted in the document difference detection processing as a position of an extraction area; and
extraction processing for extracting an equivalent of the extraction unit from the extraction area, storing an equivalent of the extraction expression in the storage means, and highlighting an equivalent of a current extraction unit when stored in the storage means after checking the input data from the left.

13. A computer program for keyword highlighting processing, the program causing a computer to execute:
extraction unit setting processing for setting an extraction unit;
extraction area setting processing for setting a position of an extraction area;
document difference detection processing for highlighting an equivalent of the extraction unit first detected in input data; and
extraction processing for defining a portion highlighted in the document difference detection processing as a position of the extraction area, extracting an equivalent of the extraction unit from the extraction area and storing the equivalent in the storage means, and highlighting an equivalent of a current extraction unit when stored in the storage means after checking the input data from the left.
